(19) United States
(12) Patent Application Publication
(10) Pub. No.: US 2006/0255092 A1
(43) Pub. Date: Nov. 16, 2006

(54) Spreading apparatus with vibrator and spreading method thereof

(76) Inventor: Yen-Ming Chen, Chia-Yi Hsien (TW)

Correspondence Address: NORTH AMERICA INTELLECTUAL PROPERTY CORPORATION, P.O. BOX 506, MERRIFIELD, VA, 22116, US

(21) Appl. No.: 11/164,064

(22) Filed: Nov. 9, 2005

(30) Foreign Application Priority Data
May 11, 2005 (CN) 200510070223.6

(51) Int. Cl. B23K 1/08; B23K 31/00; B23K 37/06

(52) U.S. Cl. 228/39; 228/180.22

(57) ABSTRACT

The present invention provides a spreading apparatus with a vibrator and a spreading method. The spreading apparatus includes a pattern plate, a scraper module, and a vibrator. The pattern plate includes at least a hole and carries a material. The scraper module scrapes the material on the pattern plate, causing the material to pass through the hole to a substrate. The vibrator, which is connected to the pattern plate or the scraper module, vibrates the pattern plate or the scraper module.

### BACKGROUND OF THE INVENTION

1. Field of the Invention

The present invention relates to a spreading apparatus and a spreading method, especially to a spreading apparatus with a vibrator and a spreading method thereof.

2. Description of the Prior Art

Generally speaking, a printed circuit board (PCB) has many devices thereon such as IC, resistor, inductor, capacitor, and many others, thereby allowing a circuitry with a certain function to be formed on the printed circuit board. For this reason, there are many welds on a printed circuit board whose locations are corresponding to the locations of the devices disposed on the printed circuit board. These welds are utilized to joint the devices and the printed circuit board. To facilitate the welding effect and to enhance the welding efficiency, the welds on the printed circuit board are often spread with some weld facilitating material before the weld is executed. Solder paste is the most frequently used material among the weld facilitating materials.

Spreading solder paste on the printed circuit board includes several regular procedural steps. First, a pattern plate is made according to the locations of the welds on the printed circuit board. Steel is often selected as the material for the pattern plate, so this kind of pattern plate is often called a solder spreading steel plate. Once a solder spreading steel plate is made, it is easy to see that the solder spreading steel plate has many holes thereon, which are corresponding to the locations of welds on the printed circuit board, allowing solder paste to pass through and to locate on the corresponding welds on the printed circuit board. Second, during the process of spreading solder paste on the printed circuit board, the solder spreading steel plate is initially placed on the printed circuit board such that the holes on the solder spreading steel plate aim at the welds on the printed circuit board. Third, solder paste is placed on the solder spreading steel plate and a scraper is utilized to scrape solder paste back and forth on the solder spreading steel plate. Therefore, when solder paste spreads over the holes, solder paste passes through the holes and locates on the welds on the printed circuit board. The aforementioned procedures are described in detail with the aid of drawings. Please refer to both FIG. 1 and FIG. 2 together. FIG. 1 illustrates a first operation of a prior art spreading apparatus, and FIG. 2 illustrates a second operation of the prior art spreading apparatus. At the beginning of the spreading process, a solder spreading steel plate 120 is placed precisely on the printed circuit board 110 such that the holes on the solder spreading steel plate 120 aim at the welds on the printed circuit board 110. When the steel scraper set 130 starts to scrape the solder paste 140 along the direction A, as shown in FIG. 1, the steel scraper 131 lifts up to move off the solder spreading steel plate 120, and the steel scraper 132 goes down to touch the solder spreading steel plate 120. When the steel scraper 132 moves along the direction A, it scrapes the solder paste 140 into the holes of the solder spreading steel plate 120. Thus, the solder paste 140 passes through the holes and locates on the welds on the printed circuit board 110. It is well known in the industry that during the process of spreading solder paste, the steel scraper set 130 scrapes the solder paste 140 back and forth on the solder spreading steel plate 120. Therefore, after the steel scraper set 130 moves along the direction A from the right side to the left side, the steel scraper 132 lifts up to move off the solder spreading steel plate 120, and the steel scraper 132 goes down to touch the solder spreading steel plate 120 (as shown in FIG. 2). Then, the steel scraper 131 moves along the direction B, and it scrapes the solder paste 140 into the holes of the solder spreading steel plate 120. Thus, the solder paste 140 passes through the holes on the solder spreading steel plate 120 and locates on the welds on the printed circuit board 110. Because the steel scraper set 130 moves back and forth along the directions A and B, all welds on the printed circuit board 110 are smeared with solder paste.

As mentioned above, the steel scraper set 130 utilizes the steel scraper 131 and the steel scraper 132 alternatively to scrape the solder paste 140 back and forth on the solder spreading steel plate 120. When the steel scraper set 130 moves from right to left, as shown in FIG. 1, the steel scraper 132 goes down and the steel scraper 131 lifts up such that the steel scraper 132 takes charge of scraping the solder paste 140. Similarly, when the steel scraper set 130 scrapes from left to right, as shown in FIG. 2, the steel scraper 131 goes down and the steel scraper 132 lifts up such that the steel scraper 131 takes charge of scraping the solder paste 140. However, due to the fact that the solder paste 140 usually adheres to the steel scraper 131 and the steel scraper 132, when the steel scraper 131 or the steel scraper 132 lifts up, the solder paste 140 is pulled up. Therefore, if there are welds at the location where the steel scraper 131 or the steel scraper 132 lifts up, the solder paste 140 is usually pulled up by the steel scraper 131 or the steel scraper 132 because of the adhesion between the solder paste 140 and the steel scraper 131 or the steel scraper 132. As a result, there will be no solder paste 140 on these welds or the amount of solder paste 140 on these welds will be deficient. Moreover, due to the adhesion between the solder paste 140 and the steel scraper 131 or the steel scraper 132, when the steel scraper 131 or the steel scraper 132 scrapes over the holes of the solder spreading steel plate 120, some solder paste 140 adheres to steel scraper 131 or the steel scraper 132, resulting in non-uniform spread of the solder paste 140.

### SUMMARY OF THE INVENTION

It is therefore an objective of the claimed invention to provide a spreading apparatus with a vibrator and a spreading method to solve the problem.

According to an embodiment of the claimed invention, a spreading apparatus is disclosed. The spreading apparatus includes a pattern plate, a scraper module, and a vibrator. The pattern plate includes at least a hole and carries a material. The scraper module scrapes the material on the pattern plate, causing the material to pass through the hole to a substrate. The vibrator, which is connected to the pattern plate or the scraper module, vibrates the pattern plate or the scraper module.

According to another embodiment of the claimed invention, a spreading method is disclosed. The spreading method comprises: placing material on a pattern plate; vibrating the pattern plate or a scraper module; and utilizing the scraper module to scrape the material on the pattern plate, causing the material to pass through the pattern plate to a substrate.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a first operation of a prior art spreading apparatus.

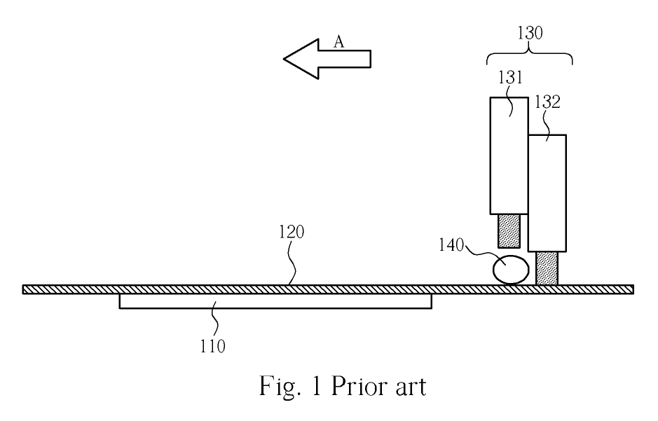

FIG. 2 is a second operation of the prior art spreading apparatus.

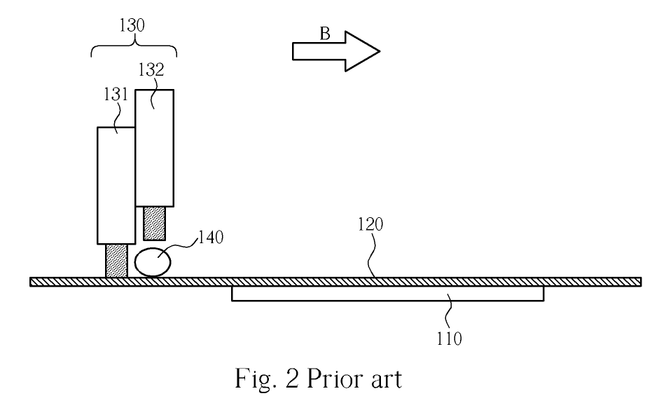

FIG. 3 is a first operation of a solder spreading apparatus according to a first embodiment of the present invention.

FIG. 4 is a second operation of a solder spreading apparatus according to a first embodiment of the present invention.

FIG. 5 is a solder spreading apparatus according to a second embodiment of the present invention.

FIG. 6 is a solder spreading apparatus according to a third embodiment of the present invention.

### DETAILED DESCRIPTION

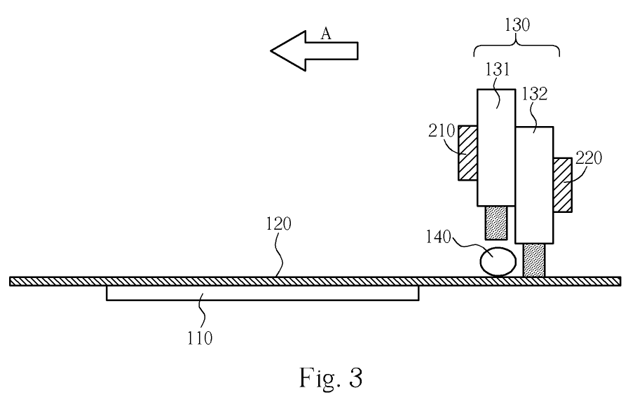

Please refer to FIG. 3. FIG. 3 illustrates a first operation of the solder spreading apparatus according to a first embodiment of the present invention. In this embodiment, the steel scraper 131 and the steel scraper 132 are equipped with a vibrator 210 and a vibrator 220 respectively. The vibrator 210 and the vibrator 220 can be any kind of vibrator that is capable of being stably set on the steel scraper 131 and the steel scraper 132. In general, the most frequently utilized vibrator is the ultrasonic vibrator, because the ultrasonic vibrator is small sized making it ideal for being set on the steel scraper 131 and the steel scraper 132. Additionally, the ultrasonic vibrator has an extremely high vibrating frequency such that it provides a high efficiency vibration. When the steel scraper set 130 starts to scrape the solder paste along 140 along the direction A, the steel scraper 131 lifts up to move off the solder spreading steel plate 120, and the steel scraper 132 goes down to touch the solder spreading steel plate 120. At the same time, the vibrator 220 is activated (i.e., turned on). When the steel scraper set 130 scrapes the solder paste 140 from right to left, the steel scraper 132 keeps vibrating due to the vibrator 220. Because the steel scraper 132 vibrates, the solder paste 140 would pass through the holes on the solder spreading steel plate 120 uniformly and locates on the welds of the printed circuit board 110 when the solder paste 140 is scraped over the holes on the solder spreading steel plate 120. The vibrator 220 vibrates the steel scraper 132, so the solder paste 140 scraped into the holes will not be drawn out by the steel scraper 132 when the steel scraper 132 scrapes transversely apart from the holes. The steel scraper 132 continues vibrating and simultaneously scraping the solder paste 140 until the steel scraper set 130 moves to the left most side of the solder spreading steel plate 120.

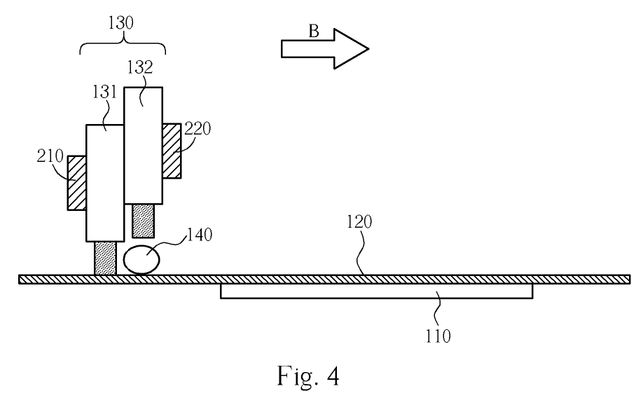

Please refer to FIG. 4. FIG. 4 illustrates a second operation of the solder spreading apparatus according to a first embodiment of the present invention. In this embodiment, after the steel scraper set 130 moves to the left most side of the solder spreading steel plate 120, the steel scraper 132 lifts up to move off the solder spreading steel plate 120, and the steel scraper 131 goes down to touch the solder spreading steel plate 120. It is noted that when the steel scraper 132 lifts up, the vibrator 220 continues vibrating. Therefore, the solder paste 140 is not easily pulled up off the solder spreading steel plate 120 when the steel scraper 132 lifts up due to the vibration of the steel scraper 132. If there is a hole at the location where the steel scraper 132 stops, the solder paste 140, which is already scraped in the hole, will not be affected when the steel scraper 132 lifts up. As a result, the non-uniform spreading problem will not occur. In this embodiment, after the steel scraper 132 lifts up and the steel scraper 131 goes down, the vibrator 220 deactivates (i.e., turns off) and the vibrator 210 turns on. Afterwards, as shown in FIG. 4, when the steel scraper 131 scrapes the solder paste 140 along the direction B from left to right, the vibrator 210 vibrates the steel scraper 131. Similarly, when the steel scraper 131 scrapes the solder paste 140, the steel scraper 131 keeps vibrating due to the vibrator 210. Because the steel scraper 131 vibrates, the solder paste 140 would pass through the holes on the solder spreading steel plate 120 uniformly and locates on the welds of the printed circuit board 110 when the solder paste 140 is scraped over the holes on the solder spreading steel plate 120. The vibrator 210 vibrates the steel scraper 131, so the solder paste 140 scraped into the holes will not be drawn out by the steel scraper 131 when the steel scraper 131 scrapes transversely apart from the holes. The steel scraper 131 continues vibrating and scraping the solder paste 140 at the same time until the steel scraper set 130 moves to the right most side of the solder spreading steel plate 120.

After the steel scraper set 130 moves to the right most side of the solder spreading steel plate 120, the steel scraper 131 lifts up to move off the solder spreading steel plate 120, and the steel scraper 132 goes down to touch the solder spreading steel plate 120. It is noted that when the steel scraper 131 lifts up, the vibrator 210 continues vibrating. Therefore, the solder paste 140 is not easily pulled up off the solder spreading steel plate 120 when the steel scraper 131 lifts up due to the vibration of the steel scraper 131. If there is a hole at the location where the steel scraper 131 stops, the solder paste 140, which is already scraped in the hole, will not be affected when the steel scraper 131 lifts up. As a result, the non-uniform spreading problem will not occur.

In short, by equipping the steel scraper set 130 with vibrators 210 and 220, the steel scraper 131 or the steel scraper 132 scrapes the sold paste 140 and vibrates at the same time, causing the solder paste 140 to pass through the holes on the solder spreading steel plate 120 and locate on the welds on the printed circuit board 110. In addition, the adhesion between the solder paste 140 and the steel scraper 131 or the steel scraper 132 becomes weaker because of the vibration. When the steel scraper 131 or the steel scraper 132 lifts up, the solder paste is not easily pulled up.

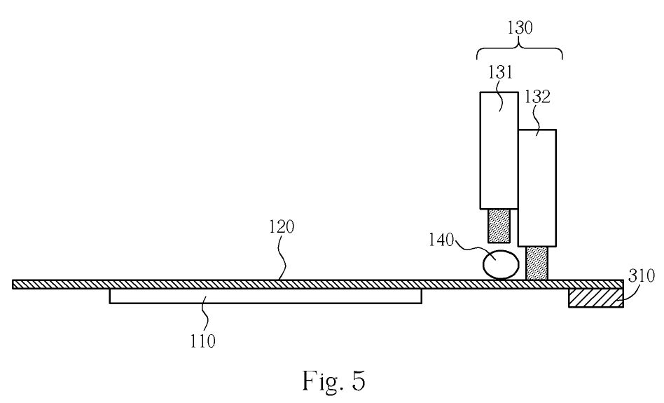

Moreover, according to the present invention, there is an alternative way to spread the solder paste 140 uniformly on the printed circuit board 110: setting a vibrator on the solder spreading steel plate 120. Please refer to FIG. 5. FIG. 5 illustrates a solder spreading apparatus according to a second embodiment of the present invention. The solder spreading steel plate 120 is equipped with a vibrator 310 such that during the process of spreading the solder paste 140, the solder paste 140 is uniformly spread on the printed circuit board 110 due to the vibration of the solder spreading steel plate 120 rather than the steel scraper 131 or the steel scraper 132. In other words, the vibrator 310 on the solder spreading steel plate 120 provides the vibration required by the solder spreading steel plate 120 or the steel scrapers 131 and 132 to prevent the adhesion of the solder paste 140 to the steel scrapers 131 and 132. The vibrator 310 is preferably an ultrasonic vibrator because an ultrasonic vibrator is small sized and light weighted making it ideal for being set on the solder spreading steel plate 120, and it also has an extremely high vibrating frequency such that it provides a high efficiency vibration.

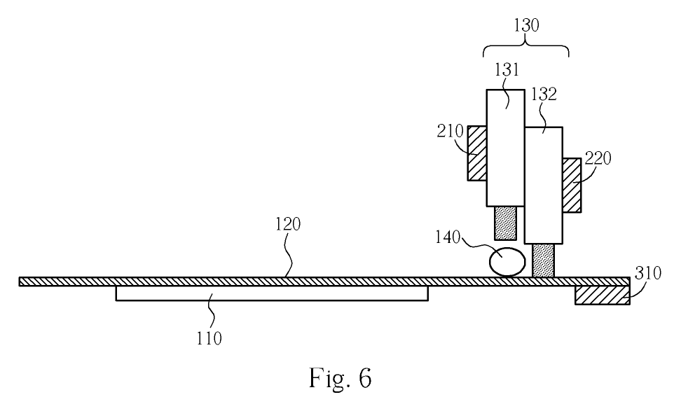

Please refer to FIG. 6. FIG. 6 illustrates a solder spreading apparatus according to a third embodiment of the present invention. In this embodiment, the steel scraper 131, the steel scraper 132, and the solder spreading steel plate 120 are equipped respectively with vibrators 210, 220, and 310 at the same time. When the steel scraper 132 moves from right to left, the vibrator 220 and the vibrator 310 turn on, causing the steel scraper 132 and the solder spreading steel plate 120 to vibrate. Therefore, the solder paste 140 passes through the holes on the solder spreading steel plate 120 and spreads uniformly on the welds on the printed circuit board 110. Because the vibrator 220 vibrates the steel scraper 132 and the vibrator 310 vibrates the solder spreading steel plate 120, the solder paste 140 scraped into the holes will not be drawn out by the steel scraper 132 when the steel scraper 132 scrapes transversely apart from the holes. Similarly, when the steel scraper 131 scrapes from left to right, the vibrator 210 and the vibrator 310 turn on, causing the steel scraper 131 and the solder spreading steel plate 120 to vibrate. Therefore, the solder paste 140 passes through the holes on the solder spreading steel plate 120 and spreads uniformly on the welds on the printed circuit board 110. Because the vibrator 210 vibrates the steel scraper 131 and the vibrator 310 vibrates the solder spreading steel plate 120, the solder paste 140 scraped into the holes will not be drawn out by the steel scraper 131 when the steel scraper 131 scrapes transversely apart from the holes.

In summary, a vibrator is set either on the steel scraper or on the solder spreading steel plate to enhance the efficiency of spreading the solder paste such that the solder paste is uniformly spread on the welds of the printed circuit board. In addition, because of the vibration of the steel scraper, the solder paste is not adhered to the steel scraper, so the amount of solder paste required in the spreading process is reduced.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A spreading apparatus comprising:
a pattern plate comprising at least a hole and carrying a material;
a scraper module, for scraping the material on the pattern plate, causing the material to pass through the hole to a substrate; and
a vibrator, connected to the pattern plate or the scraper module, for vibrating the pattern plate or the scraper module.

2. The spreading apparatus of claim 1, wherein the material is a solder paste.

3. The spreading apparatus of claim 1, wherein the pattern plate is a steel plate.

4. The spreading apparatus of claim 1, wherein the scraper module comprises at least a scraper.

5. The spreading apparatus of claim 4, wherein the scraper is a steel scraper.

6. The spreading apparatus of claim 1, wherein the vibrator is an ultrasonic vibrator.

7. The spreading apparatus of claim 1, wherein the substrate is a printed circuit board.

8. A spreading method comprising:
placing material on a pattern plate; and
vibrating the pattern plate or a scraper module, and utilizing the scraper module to scrape the material on the pattern plate, causing the material to pass through the pattern plate to a substrate.

9. The method of claim 8, wherein the material is a solder paste.

10. The method of claim 8, wherein the pattern plate is a steel plate.

11. The method of claim 8, wherein the scraper module comprises at least a scraper.

12. The method of claim 11, wherein the scraper is a steel scraper.

13. The method of claim 8, wherein the step of vibrating the pattern plate or a scraper module further comprises utilizing an ultrasonic vibrator to vibrate the pattern plate or the scraper module.

14. The method of claim 8, wherein the substrate is a printed circuit board.
